(19) United States
(12) Patent Application Publication
(10) Pub. No.: US 2013/0024178 A1
(43) Pub. Date: Jan. 24, 2013

(54) PLAYBACK METHODOLOGY FOR VERIFICATION COMPONENTS

(71) Applicant: Narendran Kumaragurunathan, Bangalore (IN)

(72) Inventor: Narendran Kumaragurunathan, Bangalore (IN)

(21) Appl. No.: 13/187,324

(22) Filed: Jul. 20, 2011

(51) Int. Cl. G06F 17/50

(52) U.S. Cl. 703/14

(57) ABSTRACT

Circuit verification structures and techniques are disclosed that relate to both passive verification components and active verification components, including verification components that cannot (or cannot easily) be synthesized to emulator hardware. In one aspect, a computer system may record signals from a circuit under test, and then play back those signals to a simulated verification component (which may be a passive verification component) for testing purposes. In another aspect, a computer system may also construct a representative behavior model of a verification component (which may be an active component) by providing input signals to a simulated verification component, recording corresponding output signals of the simulated verification component, and using the input and/or output signals to construct a representative behavior model of that verification component. The representative behavior model may be synthesized to hardware and used in association with verification of at least a portion of the circuit under test.

### BACKGROUND

1. Technical Field

This disclosure generally relates to verification of circuits or devices under test. More specifically, this disclosure relates to using playback methodology in combination with verification components in order to verify circuits under test, or portions thereof.

2. Description of the Related Art

Emulation is a verification methodology in which a circuit design may be synthesized to hardware such as the gates on FPGAs (field-programmable gate arrays) or other hardware-based emulation devices. Once a design is synthesized to hardware, it may be possible to perform verification at a faster speed than if the design were to be simulated using software.

In carrying out verification of a circuit or device, different types of testing may be performed using various testing logic. Some testing logic may not easily be reduced and synthesized to an FPGA or other hardware—for example, testing logic that requires generation and/or use of pseudo-random numbers. Accordingly, when a testing statement or component cannot be synthesized to hardware, the verification process may be slowed.

### SUMMARY OF EMBODIMENTS

In one embodiment, a method is disclosed, comprising a computer system playing back a series of recorded signals relating to a verification component for a circuit under test, wherein the computer system is configured to verify operation of at least a portion of the circuit under test using the verification component. In a further embodiment, the playing back includes the computer system providing the series of recorded signals to a software simulation of the verification component, wherein the verification component is a passive verification component. In yet a further embodiment, the series of recorded signals include one or more signal values corresponding to one or more identified signals of the circuit under test. In a further embodiment, the method comprises the computer system performing one or more verification actions in response to the software simulation of the verification component receiving the one or more signal values corresponding to the one or more identified design signals. In another further embodiment, playing back includes the computer system providing the series of recorded signals to an emulator configured to emulate the at least a portion of the circuit under test, wherein the series of recorded signals include one or more signal values corresponding to one or more identified signals for the circuit under test. In a further embodiment, the method comprises the computer system generating the series of recorded signals from a software simulation of the verification component. In yet a further embodiment, the software simulation is running on the computer system, and wherein the generating the series of recorded signals includes the computer system causing one or more signal values corresponding to one or more identified signals of the circuit under test to be provided to the software simulation of the verification component. In another further embodiment, the playing back includes playing back a first set of one or more signals to a software simulation of a passive verification component and playing back a second set of one or more signals to an emulator configured to emulate the at least a portion of the circuit under test.

In another embodiment, a system is disclosed, comprising a processor and a computer-readable storage medium having instructions stored thereon that are executable by the processor to cause the computer system to perform operations comprising playing back a series of recorded signals relating to a verification component for a circuit under test and verifying operation of at least a portion of the circuit under test using the verification component. In a further embodiment, the playing back includes providing the series of recorded signals to a software simulation of the verification component, wherein the series of recorded signals include one or more signal values corresponding to one or more identified signals of the circuit under test, and wherein the verification component is a passive verification component. In yet a further embodiment, the operations further comprise prior to the playing back, receiving the one or more signal values from an emulator configured to emulate the at least a portion of the circuit under test. In another further embodiment, the playing back includes providing the series of recorded signals to an emulator to which the computer system is configured to connect, wherein the emulator is configured to emulate the at least a portion of the circuit under test, and wherein the verification component is an active verification component. In yet a further embodiment, the operations further comprise providing input to a software simulation of the verification component, and generating, from the software simulation, one or more signal values corresponding to one or more identified signals for the circuit under test. In another further embodiment, the playing back includes generating a synthesizable behavioral model of the verification component, and wherein the verification component is an active verification component.

In another embodiment, a computer-readable storage medium is disclosed, the medium having instructions stored thereon that are executable by a processor of a computer system to cause the computer system to perform operations comprising recording a series of signals relating to a verification component for a circuit under test, and playing back the recorded series of signals. In a further embodiment, the verification component is a passive verification component, and the playing back the recorded series of signals comprises playing back to a software simulation of the passive verification component. In yet a further embodiment, the operations further comprise receiving the series of signals from an emulator configured to emulate at least a portion of the circuit under test, wherein the received series of signals correspond to one or more identified signals of the circuit under test. In another further embodiment, the verification component is an active verification component, and the playing back the recorded series of signals comprises building a synthesizable behavioral model of the active verification component. In a further embodiment, the operations further comprise configuring an emulator to emulate the synthesizable behavioral model of the active verification component and at least a portion of the circuit under test. In a further embodiment, the operations further comprise using hardware description language (HDL) data, Verilog data, or graphic database system II (GDSII) data to build the synthesizable behavioral model of the active verification component.

The teachings of this disclosure, as well as the appended claims, are expressly not limited by the features and embodiments discussed above in this summary.

### BRIEF DESCRIPTION OF THE DRAWINGS

FIG. 1 is a block diagram illustrating one embodiment of a testing system.

FIG. 2 is a block diagram illustrating one embodiment of a system configured for verification-related signal playback.

FIG. 3 is a flow chart of a method involving play back of a recorded series of signals (which may involve passive verification components, in some embodiments).

FIG. 4 is a flow chart of another embodiment of a method involving play back of a recorded series of signals (which may involve active verification components, in some embodiments).

FIG. 5 is a block diagram illustrating one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Processor.” This term has its ordinary and accepted meaning in the art, and includes a device that is capable of executing instructions. A processor may refer, without limitation, to a central processing unit (CPU), a co-processor, an arithmetic processing unit, a graphics processing unit, a digital signal processor (DSP), etc. A processor may be a superscalar processor with a single or multiple pipelines. A processor may include a single or multiple cores that are each configured to execute instructions.

Testing of a circuit design can be performed using simulation software, programmable hardware (emulators), or combinations thereof. Different verification components may be used in such testing. While it is often considerably faster to use verification components as part of an emulator, rather than a simulator, a disadvantage of some verification components is that they cannot easily be synthesized to emulator hardware (e.g., verification components involving randomization, stimulus generation, response generation, etc.). In this case, execution of testing may be slowed, as a (faster) emulated portion of a circuit under test may have to wait for a simulated verification component to finish processing before further input is provided (e.g., new testing values). Test execution may also be slowed in the event that portions of the circuit under test are simulated, rather than emulated (because in this case, putting the portions of the circuit on simulation may slow them below the level of the simulated verification component(s).) The intent of such testing may be to develop good system software along with the design and to find bugs that requires long simulation time or depends on user inputs. Accordingly, structures and techniques are disclosed herein for playback methodologies that allow verification to be performed more quickly, particularly in verification environments where one or more verification components are not easily synthesized.

As further described below, in one embodiment, signals are captured from an emulator, recorded, and then played back to one or more passive verification components that are simulated in software. In another embodiment, signals are captured from an active verification component (simulated in software), recorded, and then played back in association with a hardware-synthesizable behavioral model of the active verification component (thus in this embodiment, playback may occur during the building of the behavioral model and/or during execution of the behavioral model on emulator.) The disclosure is not thus limited, however, and additional embodiments are described herein.

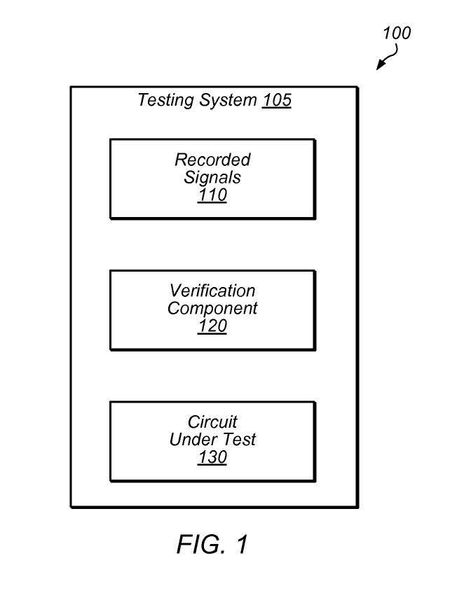

Turning now to FIG. 1, a block diagram 100 is shown of one embodiment of a testing system 105. As depicted, testing system 105 includes recorded signals 110, verification component 120, and circuit under test 130. Testing system 105 may also include a processor and one or more computer-readable storage mediums (which may be used to store executable instructions). Testing system 105 may include an emulator such as emulator 210 in some embodiments, and may also include a computer system such as 220 in various embodiments. In the embodiment of FIG. 1, testing system 105 is configured to play back recorded signals 110, which relate to verification component 120. In various embodiments, verification component 120 may be an “active” component, a “passive” component, or other types of component(s).

As used herein, the term “passive verification component” refers to a component that is not configured to provide data to a circuit under test. For example, a passive verification component may be a “checker” that is logically programmed to check one more signals, values, etc. of the circuit under test. This checking can be done in order to verify that all or a portion of the circuit under test is operating according to a design specification. One example of a checker (written in pseudo-code) is the statement “at a random time between 250 and 350 microseconds later than the time the value of a bit BUS1_BIT0 transitions from 0 to 1, check the value of a different bit BUS2_BIT0” against a particular value (e.g., check if BUS2_BIT0==1). More complex checkers are possible, of course, and may differ in type than the example above. Another type of a passive verification component, for example, is an “assertion.” An assertion verification component may assert a logical condition that is assumed to be true by the designer(s) of a circuit under test (such as circuit 130 or 215). As one example, a designer might assert that “SIGNAL_A==SIGNAL_B̂SIGNAL C” (where the ‘̂’ stands for the XOR operation). Such an assertion component might thus be configured to monitor SIGNAL_A, SIGNAL_B, and SIGNAL_C, and if the asserted condition is ever observed to be false, an exception might be created, or another verification action might occur (e.g., using verification action module 270). Other kinds of passive verification components are possible and are contemplated (e.g., functional verification components.)

Accordingly, passive verification components may be configured to receive various signals. Continuing the examples from the paragraph above, one or more passive verification components might be configured to receive values for signals such as BUS1_BIT0, BUS2_BIT0, SIGNAL_A, SIGNAL_B, and SIGNAL_C. These signals may correspond to one or more identified signals of a circuit under test (e.g., circuit 130 or 215), and may refer to a signal used by an emulation (or simulation) of a circuit under test. Such a signal may be present within a circuit under test as part of the circuit's design, or may also be a signal introduced for purposes of testing. In some embodiments, an identified signal of a circuit under test may be an internal signal (e.g., bus line value, transistor value, register and/or intermediate value, or other value within the circuit under test), or may be an external signal being provided to the circuit under test, or an external signal outgoing from the circuit under test (e.g., a signal being output from the circuit under test). Passive verification components are not limited to the examples above, however, and many types of passive verification components are possible.

Verification components (such as component 120) may also be active verification components in some embodiments. As used herein, the term “active verification component” refers to a component that is configured to provide data to at least a portion of a circuit under test. Active verification may probe one set of defined signals and respond with another set of defined signals, and may be used to verify at least a portion of a circuit under test (such as circuit 130 or 215). Accordingly, in one embodiment, an active verification component is any component that emulates or simulates a device or circuitry with which a circuit under test is designed to interact. For example, if the circuit under test is a memory controller, an active verification component may be used to represent a DRAM module (e.g., a DRAM module with which the circuit under test is designed to communicate). In this example, an active verification component might be a emulation, simulation, or model of a DRAM module. The active verification component may be used instead of the actual DRAM module itself, as in some embodiments it may be difficult or impossible to use the DRAM module due to disparate timing or operating speeds of a circuit under test. Many types of active verification components are possible, and can include modeled, simulated, and/or programmed circuitry representing busses, network devices, video cards or video devices, other peripheral devices, etc. Active verification components are not limited to these examples, however. (Note that as used herein, a “simulated” component refers to a component that is simulated via a program running on one or more processors, rather than being emulated in FPGA or other hardware.)

In the embodiment of FIG. 1, recorded signals 110 may correspond to signals arising from different sources, and may be played back to different destinations, devices, or programs in various embodiments for verification-related purposes for circuit under test 130. For example, in a first embodiment, recorded signals 110 correspond to signals originating from an emulator that is configured to emulate circuit under test 130. In this embodiment, signals are captured from the emulator and later “played back” to a software simulation of a verification component 120. (Verification component 120 may be “passive” in this embodiment.)

In a second embodiment, recorded signals 110 correspond to signals that originate not from an emulator, but instead from a software simulation of verification component 120 (which may be an “active” component in this embodiment). Recorded signals 110 may then be stored in a behavioral model of the (active) verification component, which may be synthesized to emulator hardware and executed for testing purposes. Play back in this embodiment may thus occur during emulator execution and/or in the creation of the behavioral model in which recorded signals 110 may be stored.

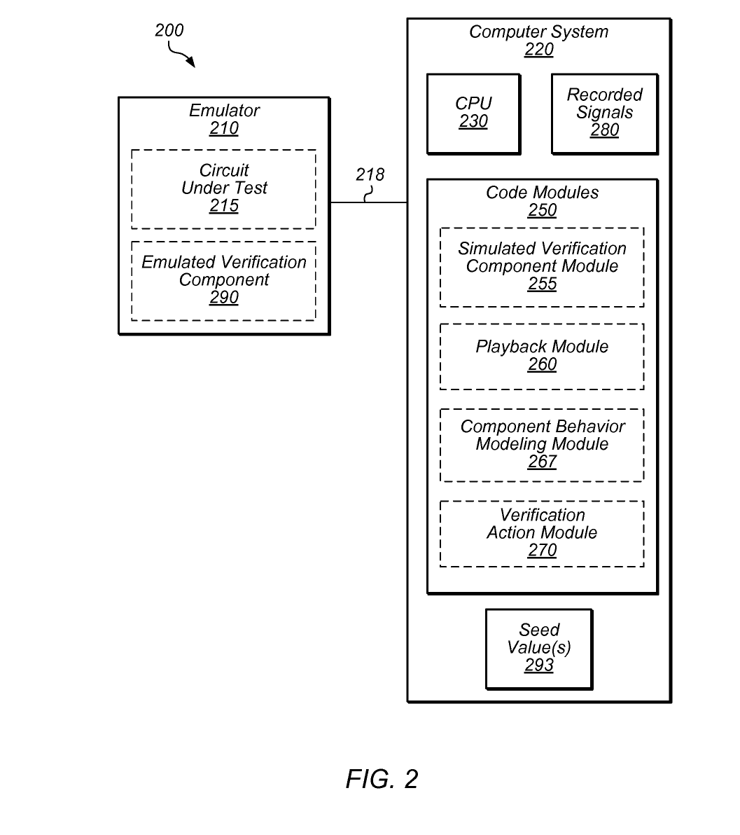

Further detail regarding signal play back relating to verification of a circuit under test and/or the recording of signals therefore can be found below relative to the discussion of FIG. 2, as well as the other figures.

Note that in various embodiments, the term “seed” or “seed value” may refer to one or more pieces of data that denote (e.g., can be used to generate) all parameters, configurations, constants, variables, register values, and/or combinations thereof that would allow an emulator and/or circuit simulator to recreate and/or reproduce any specific emulation sequence or simulation sequence. In other words, a seed may allow particular behaviors or sequences to be exactly reproduced any number of times. In one embodiment, a seed is an integer value that determines some or all values upon which an emulation or simulation depends for its resulting behavior and/or output sequences. Thus, a seed value may be an integer or other numeric value in some embodiments, but is not thus limited. Note that use of seed values may be applied, in various embodiments, to passive components, active components, a circuit under test, any portion or combination thereof, and/or any portion of an emulator and/or simulator. Different seeds may be used to create different values for different test runs.

Turning now to FIG. 2, a block diagram is shown of a system 200 that is configured for verification-related signal playback. As shown, system 200 includes an emulator 210 connected to a computer system 220 via one or more links 218. Emulator 210 may be an FPGA-based emulator or any other type of programmable hardware. In the embodiment of FIG. 2, a portion of emulator 210 can be configured to include circuit under test 215 (or a portion thereof), while another portion of emulator 210 may be configured to include an emulated verification component 290. Computer system 220 may include a processor (CPU) 230, recorded signals 280, and code modules 250.

Circuit under test 215 may be any portion of a circuit that is being emulated (tested) in hardware. Emulated verification component 290 may be configured to emulate one or more verification components (or portions thereof) in various embodiments. In one embodiment, emulated verification component 290 includes one or more “active” verification components. Circuit under test 215 and emulated verification component 290 may be created on emulator 210 using any technique as would be known to those of skill in the art, such as modifying an FPGA according to VHDL files or other source files. Computer system 220 may be configured to create (e.g., model, emulate, or “behave as”) circuit under test 215 and/or emulated verification component 290 by sending commands to emulator 210 via link 218, which may be any suitable connecting medium(s) (e.g., one or more busses, network connections via one or more networks, peripheral connections, interchanges, etc.) Circuit under test 215 and emulated verification component 290 may occupy different portions of emulator 210, or they may share any and all portions of emulator 210 (i.e., the logic in emulator 210 may be wholly or partly shared by circuit under test 215 and/or verification component 290 in various embodiments). Emulator 210 may be configured to send information back to computer 220 (which may likewise be configured to receive such information). This information may relate to circuit under test 215 and/or emulated verification component 290, and may include, for example, run-time data, results, values stored in registers, debugging data, and other data.

Code modules 250 includes one or more modules that may be stored on one or more computer-readable storage mediums in various embodiments. In the embodiment of FIG. 2, four modules are shown—a simulated verification component module 255, a component behavior modeling module 267, a playback module 260, and a verification action module 270. Code modules 250 may include any number of libraries, source files, executables, GUIs, script code, batch files, configuration settings and/or configuration files, as well as other files and/or computer program related objects. Code modules 250 may include, be interpreted from, and/or compiled from one or more different computer-related programming languages, such as C, C++, Java, VHDL, etc. In some embodiments, portions of code modules 250 may be part of an operating system or other software (e.g., drivers, data format translators, etc.)

In the embodiment of FIG. 2., one of code modules 250 is simulated verification component module 255. Simulated verification component module 255 is configured to simulate one or more verification components, which may include execution, management, configuration, communication, etc., of the one or more verification components in various embodiments. In one embodiment, these simulated verification components may include one or more passive components, simulation of which may comprise a software program running on a processor (e.g., CPU 230) having one or more input signals (e.g., that are stored in recorded signals 280) played back. Prior to these input signals being received by a simulated verification component, however, the signals may be identified and captured from a source. The source of input signals may be an emulation of circuit under test 215 that is running on emulator 210. Accordingly, simulated verification component module 255 may include one or more passive verification components that are configured to receive one or more input signals corresponding to signals from circuit under test 215 in one embodiment. (These signals from circuit under test 215 may be generated, e.g., as a result of one or more emulator executions.)

In one embodiment, the set of all the signals used by all passive components in a verification environment could be called a list of passive component signals (LPCS). In this embodiment, an emulation build with these signals enabled for dump would be created after identifying the LPCS.

In the embodiment of FIG. 2, signals generated by emulator 210 (i.e., signals to be recorded) may be identified by playback module 260. In various embodiments, the identified signals may be one or more signals of circuit under test 215, one or more signals of emulated verification component 290, or both. Playback module 260 may be configured to identify signals via human input (e.g., via input commands, editing of a configuration file, etc.) In other embodiments, playback module may be configured to identify signals automatically (e.g., by analyzing a list of passive verification components, which may be contained or maintained by simulated verification component module 255). Playback module 260 may make the identified signals available to other modules (e.g., modules 255, 267, and 270) as well as any other portion of computer system 220, and modules 255, 267, and 270 are configured to use identified signals of circuit under test 215 and/or emulated verification component 290 in various embodiments.

In the embodiment of FIG. 2, playback module 260 is configured to record identified signals from emulator 210 to one or more computer readable storage media. Recorded signals 280 represents a computer-readable storage medium configured to store one or more series of recorded signals, each of which may include one or more signal values corresponding to one or more identified signals. Accordingly, in this embodiment, playback module 260 may capture or otherwise receive signals from emulator 210 via link 218. The signals may be received and/or recorded in any suitable format(s), such as a continuous analog waveform having any value in a range of values at any given time, a sampled analog waveform in which values are sampled at certain times but not others (e.g., at certain points in the clock cycle), or digital waveforms (either continuous or sampled) in which values are characterized into binary signals (e.g., high/low or one/zero, rather than sampled voltage values such as +1.24V/−1.19V, for example). For storage purposes, recorded signals may be compressed (either dynamically during emulator runtime as signals are received, or during post-processing afterward) and may be de-compressed upon play back to a verification component. The signals recorded may be from or correspond to signals from circuit under test 215 and/or emulated verification component 290 in various embodiments.

In various embodiments, recorded signals 280 can be played back to one or more simulated verification components by playback module 260. In one embodiment, at least one passive verification component is included in the one or more simulated verification components to which signals are played back. By receiving played back signals, a simulated verification component may allow for quicker verification to occur in some embodiments. This may occur, for example, because signal sources (e.g., emulator 210) do not have to wait for the verification component to process a first set of one or more signals in order to generate additional signals. Instead, the signal source may generate a large number of signals (i.e., multiple sets of signals) at once, which can later be recorded and played back (allowing the signal source, in one embodiment, to operate at faster emulator speed rather than waiting for a simulation between generating sets of signals).

In the embodiment of FIG. 2, simulated verification components that received played-back signals may run on computer system 220 (e.g., via stored instructions that are contained in simulated verification component module 255). The playing back of recorded signals may include playing back one or more first signals to one or more simulated verification components, and playing back one or more second signals to one or more different simulated verification components. In other words, any given recorded signal(s) may be played back to any given simulated verification component(s). As further discussed below, various actions may be taken by playback module 260 and/or verification action module 270 before, during, and/or after signal play back to a simulated verification component (which may be a passive verification component).

Accordingly, in one embodiment, only the passive verification components may be compiled for simulation (a “PVCC” (passive verification component compile)). Such a compilation may include creating an empty design for this purpose or fake design signals, in some embodiments. A PVCC may be connected to its SV-interface signals or dummy design signals, on which a waveform may be played back later.

In another aspect of the embodiment of FIG. 2, signals that are output by one or more simulated verification components (rather than, e.g., from emulator 210) are stored in recorded signals 280. In one embodiment of this aspect, one or more active verification components are simulated by verification component module 255, and output from the simulated active verification component(s) is stored in signals 280. Signal play back, in these embodiments, may comprise building a behavioral model of the one or more active verification components. Such a behavioral model may be synthesized to emulator hardware as emulated verification component 290, and accordingly, play back may also comprise executing emulated verification component 290 such that internally stored signals are played back on the emulator (e.g., to circuit under test 215). Hardware description language (HDL) data, Verilog data, or graphic database system II (GDSII) data are used in some embodiments to build a synthesizable behavioral model of an active verification component. Further features and embodiments in regard to behavioral model play back and emulated verification component play back are described below.

In the embodiment of FIG. 2, one or more signals may be identified for play back in association with a behavioral model and/or emulated verification component. Accordingly, playback module 260 may be configured to identify and/or capture signals that are output by one or more simulated verification components (such as those configured or managed by simulated verification component module 255) rather than, e.g., identifying and/or capturing signals output by emulator 210. These one or more simulated verification components from which signals are identified include one or more active verification components (for example, the above-discussed component for a DRAM module) in several embodiments. (Note that active verification components may be part of a “testbench” used for verifying the circuit under test 215, and may produce signals that serve as inputs to the circuit under test). In these embodiments, identifying signals to be recorded can be performed in a variety of ways similar to those described above with respect to identifying signals from emulator 210 in paragraph 34 (e.g., a list can be manually or automatically compiled, etc.) Accordingly, the process for signal identification can be a non-automated continuous and manual process, though automation can also used via (for example) system-verilog interfaces and scripts. The set of all the signals used by all active components in a verification environment can be termed a “LACS” (List of Active Component Signals).

In embodiments in which an active verification component is simulated, the active verification component may require one or more signals prior to producing one or more output signals that are identified and/or recorded. In some embodiments, these signals may be self-generated (e.g., a random interrupt generator). In other embodiments, the signals may be generated externally and provided as inputs. In the case of an active verification component that simulates a DRAM module, for example, the component may require input for a read operation that includes a “memory start address” and a “number of bytes” to be read. Likewise, a memory write operation for a DRAM active verification component might require input that comprises a “memory start address,” a “number of bytes to be written,” and the actual data bytes to be written into memory. Once input is provided to a (simulated) active verification component, the simulation of the active verification component can produce one or more output signals (e.g., the number of bytes read, an error code status indicating success, failure, and/or other information, etc.) Many different types of active verification components are possible, and thus the embodiments disclosed herein are of course not limited to a DRAM module.

Input may be provided to a simulated active verification component from various sources. In one embodiment, input is provided manually (e.g., a human enters an input stream of one or more inputs, or enters commands into a file which is read by playback module 260, or input is entered into a testing system via a prompt on a display screen, from a seed, etc.) Input may also be provided using automatic techniques. For example, a script program (or other type of program) may run in order to provide input signals to the simulated active verification component. Signals provided through programmatic means may be time-adjusted in some embodiments to accommodate the execution speed of the simulated component (e.g., an input waveform or other signal might be slowed down, or provided in only limited portions at a time, in order to avoid possibly overwhelming a simulated component in simulated verification component module 255).

In some embodiments, another source for input to a simulated active verification component is a model of circuit under test 215. In such a model, a (highly) simplified version of the circuit under test may be simulated via software, and may produce output for an active verification component. (A model may also be simulated by manually entering input). An initial seed value may be used with a model of the circuit under test in some embodiments. In these embodiments, the seed value(s) cause a model to output particular signals which are then provided to one or more simulated (active) verification components. For example, a certain seed value might cause the model of the circuit under test to send outputs for a particular a address range, and particular data values for a memory write to that address range. Using different seed values for different will result in different output values from the model of circuit under test 215 in various embodiments. Accordingly, using two or more seed values may cause two or more different sets of outputs from a model of a circuit under test.

Thus, in accordance with the above, signals output from a model of a circuit under test (or signals from another source) can be input to a simulated verification component that is run by simulated verification component module 255. The input signals to the simulated verification component may be processed by the simulated verification component to produce a corresponding output (for example, an error status indicator, data bytes read from a certain address range in memory, etc.) This output from a simulated verification component can then be captured and recorded by playback module 260 in various embodiments. In these embodiments, one or more outputs from a simulated verification component can be recorded and compiled for multiple different test runs (e.g., test runs based on different initial seed values). Accordingly, by using multiple initial seeds, a plurality of different outputs for a given simulated verification component can be obtained. One or more output signals from the simulated verification component may then be stored in recorded signals 280. Accordingly, in some embodiments, recorded signals 280 includes a number of output signals corresponding to different test runs.

In embodiments where output signals from a simulated verification component are stored by recorded signals 280, play back of recorded signals 280 may include the creation of a behavioral model of that simulated verification component (which may be an active component). A component behavioral modeling module 267 may be used to create such model of a simulated verification component. Such a behavior model may represent a “limited intelligence” of the active verification component. For example, rather than containing the full logical abilities of an active verification component, the model may instead simply contain logic that reflects a limited set of behavior. This limited set of behavior may correspond to and be derived from the recorded signals stored in 280 that correspond to one or more input test runs on a simulated verification component. Consider the DRAM module example used above. The different number of read/write events that might occur over the enter address range of a DRAM module may be countless. Accordingly, an actual enumeration of all possible behaviors of a DRAM module might be virtually impossible. However, in association with verification, it may be entirely sufficient in some embodiments to simply have the ability to mimic a limited set of functionality of the DRAM module over a limited set of inputs (and corresponding limited set of outputs). As one example, if a testing protocol for circuit under test 215 calls for ten specific writes to DRAM, followed by ten specific reads from the DRAM, then a limited-intelligence behavioral model for the DRAM only needs to be able to recognize ten different (groups of) inputs for the memory writes, and to be able to output a matching one of ten different (groups of) outputs that corresponds to those inputs. There is no need, in this case, to be able to perform every single possible function of the DRAM module, as it may be known in advance that most of these functions will never be called for (e.g., when one or more given seed values are utilized).

Accordingly, a limited-intelligence behavioral model of a verification component may be much less complex than the full functionality of such a device. The limited-intelligence behavioral model may then be used in place of the verification component itself for purposes of testing in some embodiments. One benefit of a limited-intelligence behavioral model is that once identified (e.g., characterized by its inputs and outputs), it may be more easily synthesized to emulation hardware than the “full intelligence” of the verification component itself. Emulated verification component 290, in some embodiments, represents an emulated version of a behavioral model of a verification component (previously simulated by module 255) that has been synthesized to emulator 210. Accordingly, emulated verification component 290 is an active verification component that is being emulated in hardware in one embodiment.

A configurable testbench (CT) component may be used in some embodiments to implement a limited-intelligence behavioral model. The CT may reflect different specific behaviors without the requirement of a separate emulator build, and may possess limited capabilities as contrasted to the full functionality of active components it might replace. A CT could also be thought as a configurable synthesizable design (e.g., like a CPU). Such a CT would be configurable through op-codes, which might be present in its memory. There could be multiple CTs (unrelated among themselves) in different testing configurations (for example, depending on the complexity of a given design verification environment). Various formats for a behavioral model of a verification component are possible, and may depend on the type of emulator 210 being used in various embodiments. For example, a model may be created in Verilog or another hardware description language. In one embodiment, analysis is performed for an active testbench component behavior relative to a particular simulation (with particular design configuration, fuse settings, seed, et. al.) and a representative behavior is extracted out, which is converted to configurable testbench (CT)-op-codes. Note that in this embodiment the representative behavior will be less complex to represent than the original test-bench component itself might be. One such group of one or more CT-op-codes (CTOCs) could be created for every testbench component.

In some embodiments, play back of signals 280 (which may include signals output from a simulated verification component) thus may comprise accessing those signals in order to build a behavioral model of the (previously simulated) verification component. In one embodiment, such play back includes building a behavioral model of an active verification component. Such a behavioral model may be synthesized to emulator hardware (e.g., as component 290). Once synthesized, the emulator version of the behavioral model may have recorded signals (e.g., the outputs from an active verification component) embedded therein. Thus, signal play back in some embodiments may include emulated verification component 290 being run in conjunction with circuit under test 215, and playing back one or more particular stored output signals in response to input signals from circuit under test 215. (E.g., if stored signals for ten different test runs based on ten different seed values are present within emulated verification component 290, then play back may comprise signals being provided to circuit under test 215 for one of the different test runs.)

Playback module 260 may include other features in various embodiments. For example, playback module 260 may be configured to perform playback in a parallel and/or multithreaded manner. For example, a first simulated verification component may have its own thread used for playback, while another simulated verification component may have another thread used for playback. In one embodiment, playback module 260 may be able to initiate, halt, resume, or terminate simulated verification component module 255 and/or one or more specific verification components simulated by module 255. In some embodiments, simulated verification component module 255 may use different application programming interfaces (APIs) as a means for receiving and/or providing signals to a simulated verification component (which may be passive or active in various embodiments). Accordingly, playback module 260 may be configured to translate recorded signals 280 into multiple formats or take other actions to render recorded signals 280 suitable for any number of different implementations of simulated verification component module 255. Simulation of active verification components may occur separately from any simulation of passive verification components in some embodiments. In general, the various features and aspects of playback module 260 may be combined in any manner as would occur to one of skill in the art. Thus, in some embodiments, all functionality described with respect to playback module 260 may be present in some embodiments, while in other embodiments, different portions of the functionality of playback module 260 may be present in various combinations.

A person of skill in the art will recognize that as used throughout this disclosure, mention of terms in the singular tense, such as “verification component,” “simulated verification component module (260),” or “emulated verification component (290),” may indicate the use of multiples instances in some embodiments. For example, while structures or techniques may be described with respect to “a” verification component, these structures or techniques can also be adapted to a plurality of verification components (any of which may contain different features, or the same, from one another). Likewise, the terms “signal, “signals,” and “series of signals” may, in various embodiments, refer to one or more values that correspond to one or more inputs and/or outputs. (Note also that in one embodiment, different values in a series of signals may be based on one or more different initial seed values.)

In the embodiment of FIG. 2, verification action module 270 may take various actions in response to or in association with actions of emulator 210 and/or modules in computer system 220 (such as playback module 260 and/or simulated verification component module 255). Verification action module may thus be configured to verify at least a portion of a circuit under test using one or more verification components. For example, verification action module may be configured to record signals, verify signals values against expected values, compile testing data across different test runs (e.g., indicating which values for which runs were not as expected), perform statistical analysis on testing data, prioritize or categorize different errors uncovered during testing, etc. Verification action module 270 may also coordinate communications between different ones of code modules 250 and/or portions of emulator 210, may coordinate signal playback, may start or stop emulator 210, may start or stop a simulation in module 255, and may start and/or stop other portions of system 220, etc., in various embodiments.

FIG. 2 also shows seed value(s) 293. These seed values may be stored on a computer-readable storage medium in some embodiments. In one embodiment, the seed values may be generated from source code or a program (e.g., such as any one of modules 255, 260, 267, and/or 270). Seed value(s) 293 can be used to create any or all of the values used by computer system 220 and/or emulator 210 in verifying circuit under test 215.

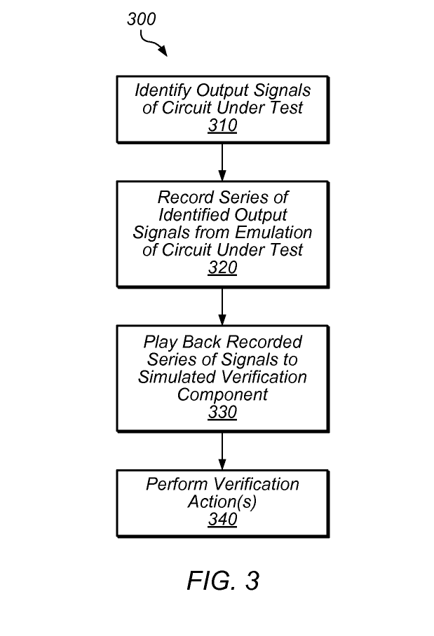

Turning now to FIG. 3, a flow chart of one embodiment of a method 300 involving play back of a recorded series of signals is shown. Method 300 may be employed in some embodiments with respect to passive verification components. It should be noted that in various embodiments of the method described below, one or more of the elements described may be performed concurrently, in a different order than shown, or may be omitted entirely. Other additional elements may also be performed as desired. Further, only some portions of some method steps may be performed in some embodiments. All or a portion of steps of method 300 may be performed by any combination of computer system 220 and/or emulator 210 in some embodiments. In particular, functionality described above with respect to various ones of code modules 250 may be used to perform some or all portions of each of the steps of method 300.

In step 310, one or more output signals of a circuit under test are identified. Identification of output signals of a circuit can be performed as described above in various embodiments—e.g., identifying signals manually, automatically, or using some combination thereof. In step 320, a series of signals relating to a verification component for a circuit under test is recorded. In one embodiment, this series of signals comprises identified output signals of an emulation of a circuit under test (e.g., circuit under test 215 as emulated by emulator 210). In some embodiments, this series of signals may be stored in recorded signals 280.

In step 330, a recorded series of signals is played back to a simulated verification component. Play back may include computer system 220 providing one or more signal values to simulated verification component module 255 (which may route the one or more signal values to simulations of one or more different verification components). In one embodiment, step 330 includes playing back one or more signal values captured from circuit under test 215 to a passive verification component (e.g., a checker or assertion). In step 340, one or more verification actions are performed (such as actions described with respect to verification action module 270).

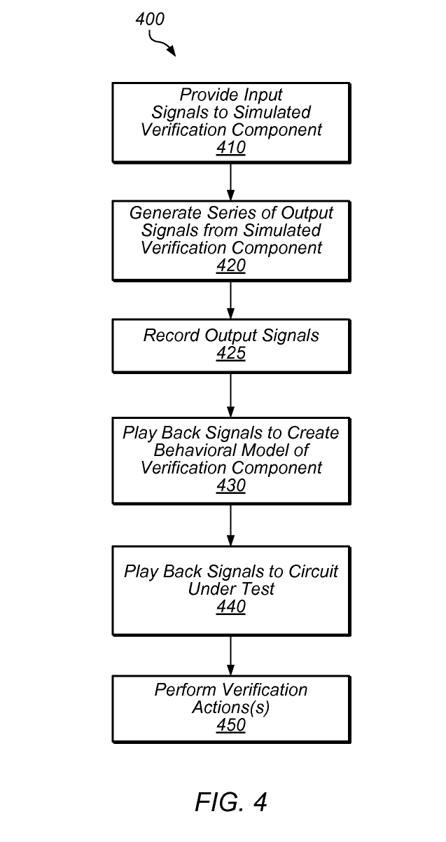

Turning now to FIG. 4, a flow chart of one embodiment of a method 400 involving play back of a recorded series of signals is shown. Method 400 may be employed in some embodiments with respect to active verification components. It should be noted that in various embodiments of the method described below, one or more of the elements described may be performed concurrently, in a different order than shown, or may be omitted entirely. Other additional elements may also be performed as desired. Further, only some portions of some method steps may be performed in some embodiments. All or a portion of steps of method 400 may be performed by any combination of computer system 220 and/or emulator 210 in some embodiments. In particular, functionality described above with respect to various ones of code modules 250 may be used to perform some or all portions of each of the steps of method 400.

In step 410, a series of one or more input signals are provided to a simulated verification component. This verification component is simulated by simulated verification component module 255 in one embodiment. In step 420, a series of one or more output signals from the simulated verification component are generated. This series of output signals corresponds to the input signals from step 410, and in one embodiment, the series of output signals represents output from a simulated active verification component. In step 425, the series of output signals is recorded (e.g., onto recorded signals 280). In step 430, the recorded signals are played back in association with creating a behavioral model of the simulated verification component. For example, play back in step 430 may comprise the recorded signals being read from a storage medium and analyzed by playback module 260 (or other computer software) in order to create a synthesizable version of an active verification component. Play back may also comprise converting the recorded signals into a format suitable for emulation hardware. Step 430 may include storing a copy of the behavioral model on a storage medium of system 220. In one embodiment, step 430 includes synthesizing the behavioral model to emulator 210 (thereby creating emulated verification component 290). Creation of emulated verification component 290 may also include synthesizing at least a portion of circuit under test 215 to emulator 210.

In step 440, signals are played back to at least a portion of a circuit under test. In one embodiment, step 440 includes emulator 210 being run, and having emulated verification component 290 provide one or more (stored) signals to circuit under test 215. The signals provided to circuit under test 215 may be in response to one or more inputs from circuit under test 215 (e.g., where emulated verification component 290 is an active component). Accordingly, play back in step 440 may comprise a synthesized limited-intelligence behavioral model providing one or more signal values to a circuit under test. In step 450, one or more verification actions are performed (such as actions described with respect to verification action module 270).

Potential advantages of some of the embodiments and features described herein with respect to passive components are that (1) it may not be required to write synthesizable checkers/assertions for emulation; (2) some checkers/assertions can only be written in non-synthesizable fashion, and the methodology described herein may allow these components to be used in emulation based verification; (3) there may be a greater overhead in learning, coding & maintaining synthesizable checkers/assertions; (4) an emulator's “design image” may not be increased as much; (5) an emulator's speed is not slowed down as much as may occur in co-simulation; and (6) there is additional possibility of coverage being part of emulation.

Potential advantages of some of the embodiments and features described herein with respect to active components are that (1) it may not be required to write synthesizable active-testbench components for emulation; (2) some active-testbench components are best written in non-synthesizable fashion, and the methodology described herein may allow these components to also be used in emulation based verification; (3) there may be a greater overhead in learning, coding & maintaining synthesizable testbench components; (4) an emulator's “design image” may not be increased as much; and (5) an emulator's speed is not slowed down as much as may occur in co-simulation. The potential advantages of the techniques and structures disclosed herein are not thus limited, however.

### Exemplary Computer System

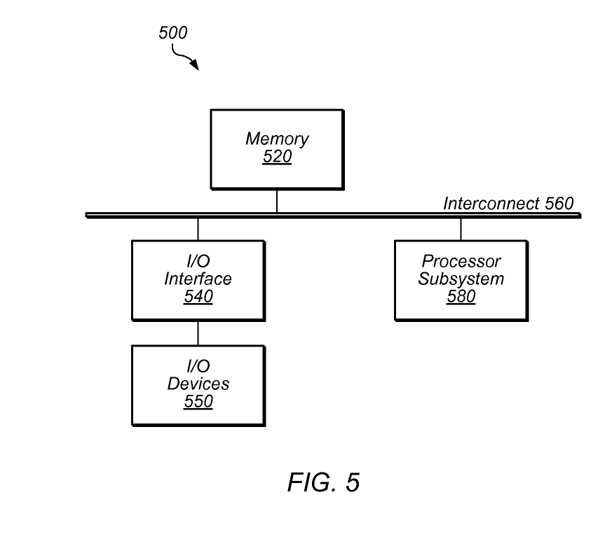

Turning now to FIG. 5, one embodiment of an exemplary computer system 500 is depicted. All or a portion of computer system 500 may be used to implement computer system 220 and/or emulator 210 in various embodiments.

Computer system 500 includes a processor subsystem 580 that is coupled to a system memory 520 and I/O interfaces(s) 540 via an interconnect 560 (e.g., a system bus). I/O interface(s) 540 is coupled to one or more I/O devices 550. Computer system 500 may be any of various types of devices, including, but not limited to, a server system, personal computer system, desktop computer, laptop or notebook computer, mainframe computer system, handheld computer, workstation, network computer, a consumer device such as a mobile phone, pager, or personal data assistant (PDA). Computer system 500 may also be any type of networked peripheral device such as storage devices, switches, modems, routers, etc. Although a single computer system 500 is shown for convenience, system 500 may also be implemented as two or more computer systems operating together.

Processor subsystem 580 may include one or more processors or processing units. For example, processor subsystem 580 may include one or more processing units (each of which may have multiple processing elements or cores) that are coupled to one or more resource control processing elements 520. In various embodiments of computer system 500, multiple instances of processor subsystem 580 may be coupled to interconnect 560. In various embodiments, processor subsystem 580 (or each processor unit or processing element within 580) may contain a cache or other form of on-board memory.

System memory 520 is usable by processor subsystem 580, and comprises one or more memory elements such as element 180 in various embodiments. System memory 520 may be implemented using different physical memory media, such as hard disk storage, floppy disk storage, removable disk storage, flash memory, random access memory (RAM—static RAM (SRAM), extended data out (EDO) RAM, synchronous dynamic RAM (SDRAM), double data rate (DDR) SDRAM, RAMBUS RAM, etc.), read only memory (ROM—programmable ROM (PROM), electrically erasable programmable ROM (EEPROM), etc.), and so on. Memory in computer system 500 is not limited to primary storage such as memory 520. Rather, computer system 500 may also include other forms of storage such as cache memory in processor subsystem 580 and secondary storage on I/O Devices 550 (e.g., a hard drive, storage array, etc.). In some embodiments, these other forms of storage may also store program instructions executable by processor subsystem 580.

I/O interfaces 540 may be any of various types of interfaces configured to couple to and communicate with other devices, according to various embodiments. In one embodiment, I/O interface 540 is a bridge chip (e.g., Southbridge) from a front-side to one or more back-side buses. I/O interfaces 540 may be coupled to one or more I/O devices 550 via one or more corresponding buses or other interfaces. Examples of I/O devices include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 500 is coupled to a network via a network interface device. In some embodiments, I/O interfaces 540 is used to couple computer system 220 to emulator 210 (e.g., via a network connection or peripheral connection).

Program instructions that are executed by computer systems (e.g., computer system 500) may be stored on various forms of computer readable storage media. Generally speaking, a computer readable storage medium may include any non-transitory/tangible storage media readable by a computer to provide instructions and/or data to the computer. For example, a computer readable storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), holographic storage, as well as storage media accessible via a communication medium such as a network and/or a wireless link.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
a computer system playing back a series of recorded signals relating to a verification component for a circuit under test;
wherein the computer system is configured to verify operation of at least a portion of the circuit under test using the verification component.

2. The method of claim 1, wherein the playing back includes the computer system providing the series of recorded signals to a software simulation of the verification component, and wherein the verification component is a passive verification component.

3. The method of claim 2, wherein the series of recorded signals include one or more signal values corresponding to one or more identified signals of the circuit under test.

4. The method of claim 3, further comprising the computer system performing one or more verification actions in response to the software simulation of the verification component receiving the one or more signal values corresponding to the one or more identified design signals.

5. The method of claim 1, wherein the playing back includes the computer system providing the series of recorded signals to an emulator configured to emulate the at least a portion of the circuit under test;
wherein the series of recorded signals include one or more signal values corresponding to one or more identified signals for the circuit under test.

6. The method of claim 5, further comprising the computer system generating the series of recorded signals from a software simulation of the verification component.

7. The method of claim 6, wherein the software simulation is running on the computer system, and wherein the generating the series of recorded signals includes the computer system causing one or more signal values corresponding to one or more identified signals of the circuit under test to be provided to the software simulation of the verification component.

8. The method of claim 1, wherein the playing back includes:
playing back a first set of one or more signals to a software simulation of a passive verification component; and
playing back a second set of one or more signals to an emulator configured to emulate the at least a portion of the circuit under test.

9. A system, comprising:
a processor; and
a computer-readable storage medium having instructions stored thereon that are executable by the processor to cause the computer system to perform operations comprising:
playing back a series of recorded signals relating to a verification component for a circuit under test; and
verifying operation of at least a portion of the circuit under test using the verification component.

10. The computer system of claim 9, wherein the playing back includes providing the series of recorded signals to a software simulation of the verification component, wherein the series of recorded signals include one or more signal values corresponding to one or more identified signals of the circuit under test, and wherein the verification component is a passive verification component.

11. The computer system of claim 10, wherein the operations further comprise:
prior to the playing back, receiving the one or more signal values from an emulator configured to emulate the at least a portion of the circuit under test.

12. The computer system of claim 9, wherein the playing back includes providing the series of recorded signals to an emulator to which the computer system is configured to connect, wherein the emulator is configured to emulate the at least a portion of the circuit under test, and wherein the verification component is an active verification component.

13. The computer system of claim 12, wherein the operations further comprise:
providing input to a software simulation of the verification component; and
generating, from the software simulation, one or more signal values corresponding to one or more identified signals for the circuit under test.

14. The computer system of claim 9, wherein the playing back includes generating a synthesizable behavioral model of the verification component, and wherein the verification component is an active verification component.

15. A computer-readable storage medium having instructions stored thereon that are executable by a processor of a computer system to cause the computer system to perform operations comprising:
recording a series of signals relating to a verification component for a circuit under test; and
playing back the recorded series of signals.

16. The computer-readable storage medium of claim 15, wherein the verification component is a passive verification component; and
wherein playing back the recorded series of signals comprises playing back to a software simulation of the passive verification component.

17. The computer computer-readable storage medium of claim 16, wherein the operations further comprise receiving the series of signals from an emulator configured to emulate at least a portion of the circuit under test, and wherein the received series of signals correspond to one or more identified signals of the circuit under test.

18. The computer-readable storage medium of claim 15, wherein the verification component is an active verification component; and
wherein playing back the recorded series of signals comprises building a synthesizable behavioral model of the active verification component.

19. The computer-readable storage medium of claim 18, wherein the operations further comprise configuring an emulator to emulate the synthesizable behavioral model of the active verification component and at least a portion of the circuit under test.

20. The computer-readable storage medium of claim 18, wherein the operations further comprise using hardware description language (HDL) data, Verilog data, or graphic database system II (GDSII) data to build the synthesizable behavioral model of the active verification component.
